(19) United States
(12) Patent Application Publication
(10) Pub. No.: US 2016/0328423 A1
(43) Pub. Date: Nov. 10, 2016

(54) SYSTEM AND METHOD FOR DATA CHANGE DETECTION AND RECENCY INDICATION

(71) Applicant: Robert Gregory Twiss, Chapel Hill, NC (US)

(72) Inventor: Robert Gregory Twiss, Chapel Hill, NC (US)

(73) Assignee: CISCO TECHNOLOGY, INC., San Jose, CA (US)

(21) Appl. No.: 14/704,055

(22) Filed: May 5, 2015

(51) Int. Cl. G06F 17/30; G06F 3/0481; G06F 3/0484

(52) U.S. Cl. CPC G06F 17/30289; G06F 3/04847; G06F 3/0481

(57) ABSTRACT

According to one aspect, a method includes determining when a change has occurred with respect to a first piece of data that is stored in a database, and causing the first piece of data to be displayed on a display screen, the display screen being in communication with the database. The method also includes causing a visual indication to be displayed on the display screen, the visual indication being arranged to be superimposed with respect to the first piece of data on the display screen, the visual indication being configured to visually indicate at least one selected from a group including qualitative information and quantitative information associated with the change, wherein the visual indication is arranged to be activated to cause details associated with the change to be displayed on the display screen.

### TECHNICAL FIELD

The disclosure relates generally to communications networks. More particularly, the disclosure relates to efficiently and effectively providing information relating to data changes in a database and information relating to the recency of the data changes.

### BACKGROUND

Many business enterprises use extensive databases which contain complex, multi-variable data. Extensive databases, e.g., databases which contain information relating to millions of components such as manufacturing parts, may include millions of data records and millions of associated documents. A single component in a database may be defined by a set of attributes, e.g., parameters.

Many related parameters associated with a component may be aggregated into parametric data. The ability to identify changes such as changes to parametric data may be important to data analytics applications and to searches performed on components with changed parametric data. The inability to efficiently identify changes to parametric data may have an adverse effect on data analytics applications and searches.

### BRIEF DESCRIPTION OF THE DRAWINGS

The disclosure will be readily understood by the following detailed description in conjunction with the accompanying drawings in which:

FIG. 1 is a process flow diagram which illustrates one method of indicating a data change or a parameter change in accordance with an embodiment.

FIG. 2 is a diagrammatic representation of a display screen associated with a database in which data change and recency indications are rendered in accordance with an embodiment of the present invention.

FIG. 3 is a diagrammatic representation of a display screen, e.g., display screen 200 of FIG. 2, in which a first data change detection and recency indication has been activated in accordance with an embodiment of the present invention.

FIG. 4 is a diagrammatic representation of a display screen, e.g., display screen 200 of FIG. 2, in which a second data change detection and recency indication has been activated in accordance with an embodiment of the present invention.

FIG. 5 is a diagrammatic representation of a display screen, e.g., display screen 200 of FIG. 2, in which a third data change detection and recency indication has been activated in accordance with an embodiment of the present invention.

FIG. 6A is a diagrammatic representation of a system which supports data change and recency indications in accordance with an embodiment.

FIG. 6B is a diagrammatic representation of a network which includes a system that supports data change and recency indications, e.g., system 600 of FIG. 6A, in accordance with an embodiment.

FIG. 7 is a process flow diagram of one method of utilizing a system which supports data change and recency indications in accordance with an embodiment.

FIG. 8 is a diagrammatic representation of a user interface which allows a user to specify a time scale associated with visual indications of how recently a data change or a parameter change has occurred in accordance with an embodiment.

### DESCRIPTION OF EXAMPLE EMBODIMENTS

### General Overview

In one embodiment, a method includes determining when a change has occurred with respect to a first piece of data that is stored in a database, and causing the first piece of data to be displayed on a display screen, the display screen being in communication with the database. The method also includes causing a visual indication to be displayed on the display screen, the visual indication being arranged to be superimposed with respect to the first piece of data on the display screen, the visual indication being configured to visually indicate at least one selected from a group including qualitative information and quantitative information associated with the change, wherein the visual indication is arranged to be activated to cause details associated with the change to be displayed on the display screen. The visual indication may be superimposed with respect to the first piece of data by overlaying the first piece of data or underlying the first piece of data.

### Description

Databases, as for example parametric databases, are used by enterprises to store complex, multi-variable data. Many of the parameters or parametric data stored in a database may be related, e.g., may refer to the same part in a manufacturing parts database. The aggregation of multiple related parameters or parametric data is a construct that is generally used in big data structures and associated data analytics applications. Individual parametric elements may change in value, description, and/or existence within a database, e.g., a manufacturing parts database, as databases are generally updated on a regular basis.

Some databases may be provided with functionality which enables relatively comprehensive parametric data searching. In some instances, it may be desirable to have relatively easy access to information relating not only to a parameter change, but also information relating to when the parameter was changed. That is, the ability for a database to visibly indicate when a data element has changed, or when a parameter has changed, and how recently such a change was made may be desirable.

In one embodiment, a data element change or a parameter change associated with a database may be efficiently and effectively visually identified. The visual identification of a change may include, but is not limited to including, providing a clear, visual evidence of a change in recency, as well as a qualitative and/or quantitative indication of how new or “fresh” the change is. Providing a qualitative and/or quantitative indication of data freshness may provide a temporal hierarchy and priorities with respect to a database. Upon flagging or otherwise identifying a change, a user may be provided with relatively quick access to specific details and/or a summary of details associated with the change. Thus, data analysts and consumers may be provided with the ability to efficiently recognize, identify, quantify, and prioritize data element changes within complex parametric databases.

A changed data element or parameter may be visually flagged such that when a display shows the changed data element or parameter, a user may view the display to readily identify information relating to how recently the data element or parameter was changed. Such visual flags, or parametric data change markers, may vary widely. By way of example, an overall database system may enable a system administrator and/or a user to define or otherwise specify what certain parametric data change markers are intended to indicate. In one embodiment, a visual flag may effectively overlay a changed data element or parameter. It should be appreciated that a visual flag or indication is not limited to overlaying a changed data element or parameter and, may instead, underlay a changed data element or parameter, or be otherwise incorporated into a changed data element or parameter. In general, a visual flag or indication may be superimposed with respect to a changed data element or parameter, e.g., superimposed over or under the changed data element or parameter

A method and/or a user interface (UI) for efficient parametric data change visualization provides a user with the ability to view a display associated with a database, and to quickly recognize that a data parameter has changed. In addition, the method and/or UI for efficient parametric data change visualization allows a user to relatively quickly determine how recently a data parameter was changed, and to efficiently obtain specifics relating to the change.

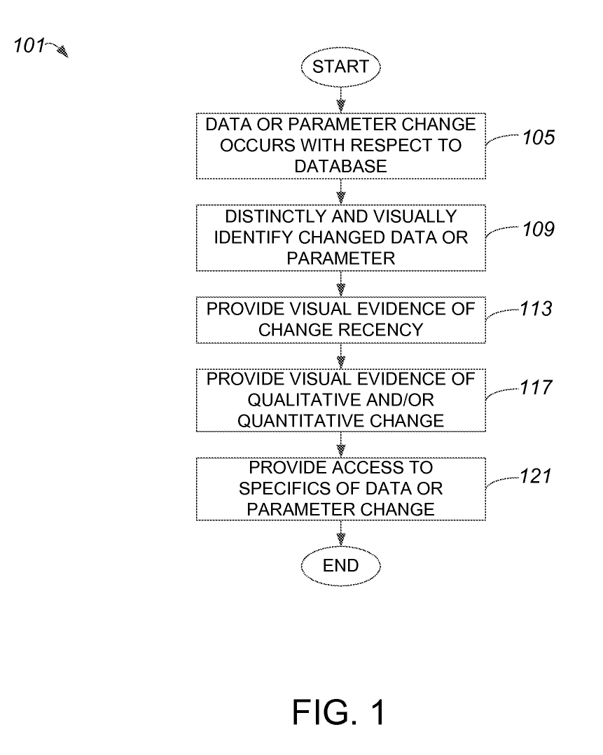

Referring initially to FIG. 1, one method of indicating a data change or a parameter change will be described in accordance with an embodiment. A method 101 of indicating a data change or a parameter change begins at step 105 in which a data or parameter change occurs with respect to a database. The database may be any suitable database, e.g., a manufacturing parts database associated with an enterprise. A data change or a parameter change may include, but is not limited to including, a change in a value, a change in a description, and/or a change in existence that relates to substantially any data or parameter stored in the database.

Once a data or parameter change occurs with respect to the database, the changed data or parameter is distinctly and visually identified in step 109. The changed data or parameter may be visually highlighted with a change marker or marker icon. The change marker may be, but is not limited to being, alphanumeric characters or text, an icon and/or a particular color. In step 113, visual evidence of how recently a change was made may be provided, and in step 117, visual evidence of a qualitative and/or quantitative change may be provided. The visual evidence, e.g., indicators, of change recency, qualitative changes, and/or quantitative changes may be provided using any suitable method.

After indicators of changes or data change markers are provided, access to specifics of a data change or parameter change may be provided in step 121. In one embodiment, indicators of changes may be activated such that specifics of a data change or parameter change may be viewed. Activating an indicator may include, but is not limited to including, positioning or hovering a cursor over the indicator displayed on a display screen, “clicking” on the indicator, or by providing a combination of keyboard and/or mouse commands. Upon activating an indicator, specifics of a data change or parameter change may be viewed, as for example in a window which opens on the display screen. Once access to specifics of a data change or a parameter change are provided, the method of indicating a data change or a parameter change is completed.

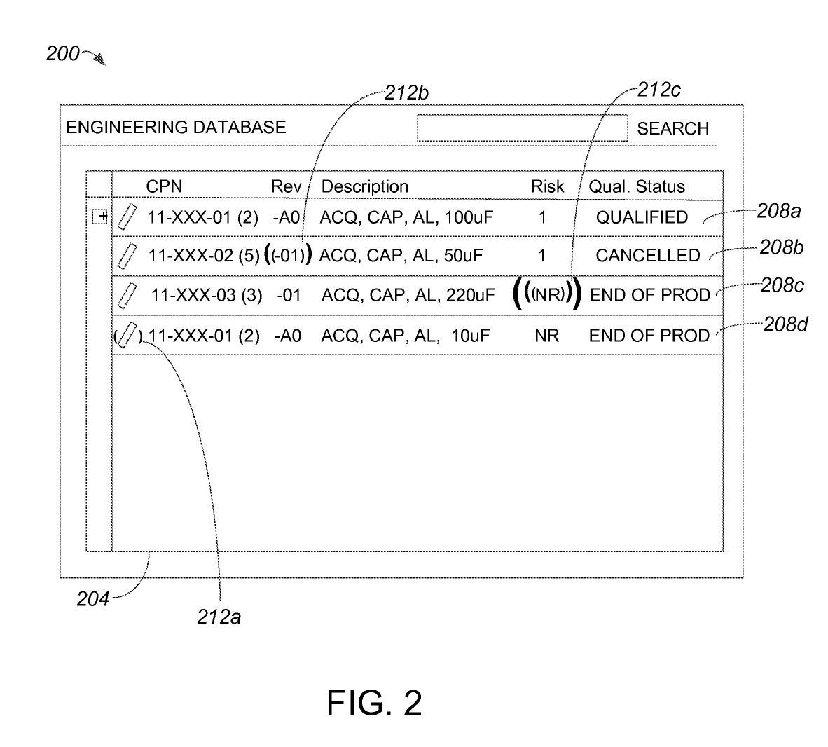

FIG. 2 is a diagrammatic representation of a display screen, as for example a display displayed on a display screen, associated with a database in which data change and recency indications are rendered in accordance with an embodiment of the present invention. A display screen 200 has a display 204 rendered thereon which includes a visual representation of contents of a database, e.g., a parametric database. Display 204 includes data entries 208a-d. Each data entry 208a-d may be a parameter grouping that is displayed in a linear fashion or in a list for convenience, and may be considered to be a parametric data entry. As shown, each parametric data entry 208a-d represents a different part or entry in a database, and includes parameters associated with the part or entry.

Visual indicators of change 212a-c are configured to indicate how recently a particular change was made to an associated parameter. A qualitative aspect of a change may be inferred from the existence of visual indicators of change 212a-c, and a quantitative aspect of the change may be inferred from the specific layout or nature of visual indicators of change 212a-c. For example, the layout of visual indicators of change 212-ac may be mapped to specific quantitative temporal information.

In one embodiment, through the use of visual indicators 212a-c, parameters within parametric data entries 208a-d which have been changed may be readily identified, in addition to a recency associated with the change. It should be appreciated that if no visual indicator of change is provided with respect to an associated parameter, that parameter may effectively be identified as not having been changed recently, within a specified time window, or never being changed.

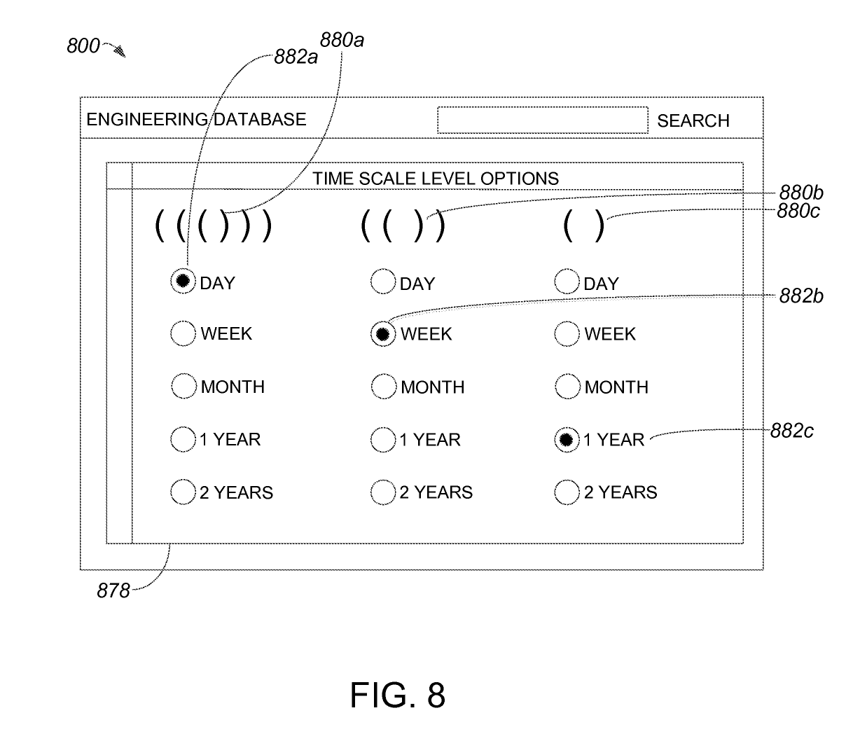

Visual indicators 212a-c may vary widely, and may be configured or otherwise selected by a system administrator or a user. Visual indicators 212a-c may include, but are not limited to including, symbols, icons, text, and/or colors. In the embodiment as shown, visual indicators 212a-c are symbols such as parentheses or brackets, with a number of parentheses indicating a time scale, e.g., how recently a change has occurred. For example, visual indicator 212a is a single pair of parentheses which may signify an older recent change than visual indicator 212b, which includes two pairs of parentheses. Likewise, visual indicator 212c is three pairs of parentheses, and may signify a more recent change than visual indicator 212b. It should be appreciated, however, that the time scale associated with visual indicators 212a-c may vary widely. The time scale, as will be discussed below with respect to FIG. 8. As shown, each set of parentheses in visual indicators 212b, 212c may be of different sizes, shapes, and/or thicknesses.

Each of visual indicators 212a-c is arranged to be activated. For example, when a cursor is placed over a visual indicator 212a-c and/or a visual indicator 212a-c is selected when a cursor is hovering over visual indicator 212a-c, additional information relating to the data or parameter, and changes to this data or parameter, associated with visual indicator 212a-c may be displayed. The additional information may include, but is not limited to, information that identifies the most recent change that occurred with respect to a piece of data or a parameter and/or information that identifies when the most recent change occurred.

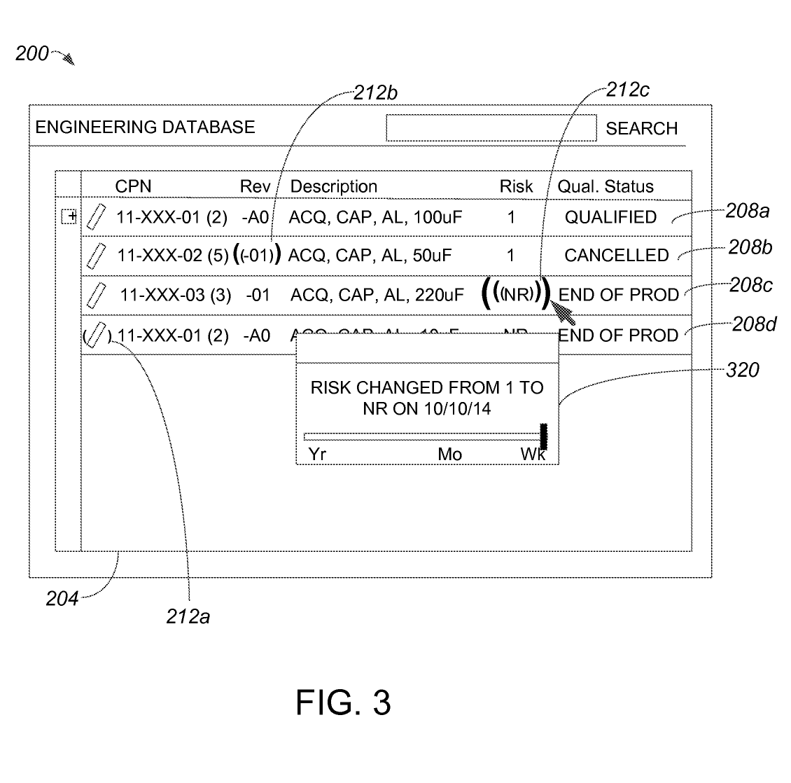

With reference to FIG. 3, display screen 200 of FIG. 2 is shown at a time at which visual indicator 212c has been activated in accordance with an embodiment of the present invention. Visual indicator 212c, as shown, is three sets of parentheses. In the described embodiment, visual indicator 212c indicates that the most recent change to associated data or a parameter, in this case a “risk” classification factor associated with data entry 208c, occurred less than a week ago, e.g., within the last day. Visual indicator 212c is displayed, in one embodiment, as an overlay over a risk factor associated with data entry 208c.

When visual indicator 212c is activated, a pop-up window 320, or a dialog box, may be displayed on display screen 200 as shown. The contents of pop-up window 320 may provide detail relating to the actual change to associated data or a parameter, as well as detail relating to when and/or how the change occurred. As shown, the contents of pop-up window 320 indicate that a “risk” classification factor changed from a rating of “1” to a rating of “NR” on Oct. 10, 2014 which, in the described embodiment, was within the last week. A timeline is also displayed in pop-up window 320 which shows how recently the risk was changed.

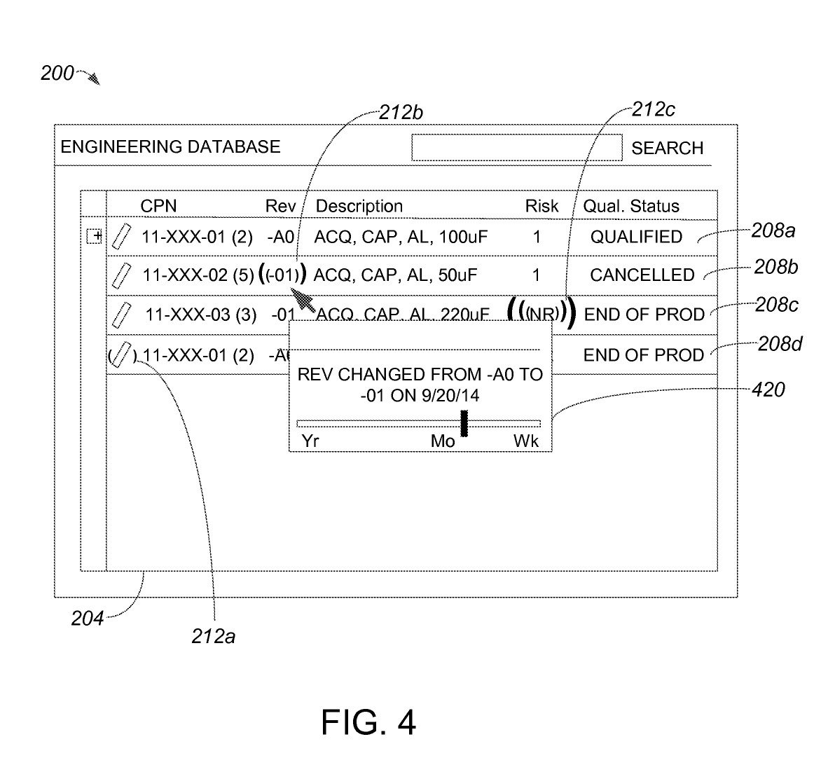

Referring next to FIG. 4, display screen 200 of FIG. 2 is shown at a time at which visual indicator 212b has been activated in accordance with an embodiment of the present invention. Visual indicator 212b, as shown, is two sets of parentheses. In the described embodiment, visual indicator 212b indicates that the most recent change to associated data or a parameter, in this case a “revision,” occurred more than a week ago but less than a month ago.

Upon activating visual indicator 212b, a pop-up window 420 may be displayed on display screen 200. The contents of pop-up window 420 may provide detail relating to the actual change to associated data or a parameter, as well as detail relating to when the change occurred. In the described embodiment, the contents of pop-up window 420 indicate that a “Rev” changed from a value or indicator of “−A0” to a value or indicator of “−01” on Sep. 20, 2014, which was less than a month ago but more than a week ago.

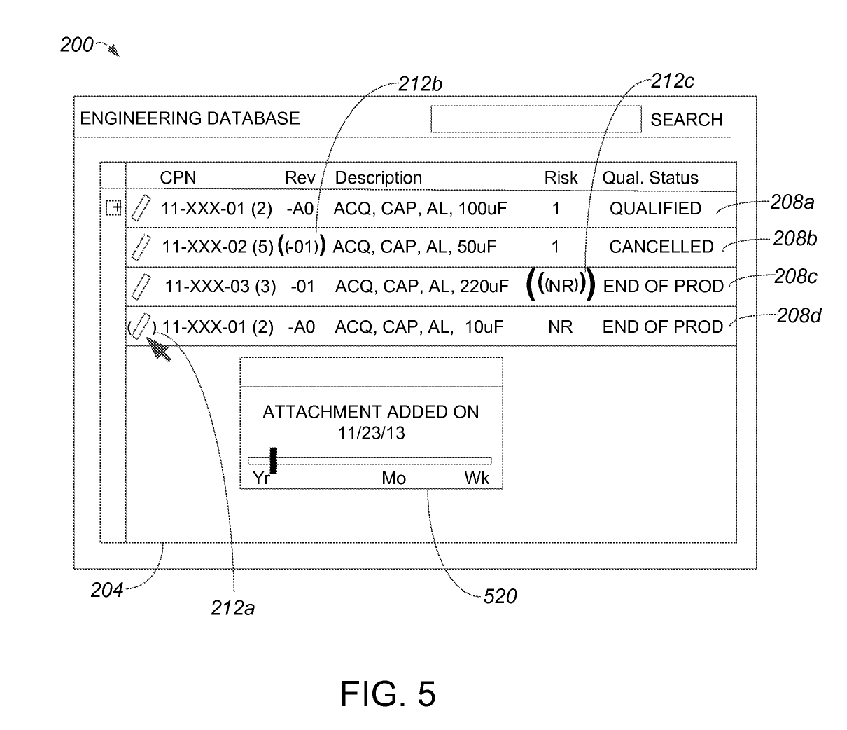

FIG. 5 is a diagrammatic representation of a display screen 200 at a time at which visual indicator 212a has been activated in accordance with an embodiment of the present invention. Visual indicator 212a, as shown, is a single set of parentheses. As shown, visual indicator 212a is arranged to indicate that a change to attachments associated with data entry 208d has occurred less than a year ago, but more than a month ago. That is, visual indicator 212a is depicted as effectively highlighting that attachments associated with data entry 208d have been added, removed, and/or otherwise updated less than a year ago, but more than a month ago.

The activation of visual indicator 212a causes a pop-up window 520 to be displayed on display screen 200. The contents of pop-up window 520 may provide detail relating to whether an attachment was added, removed, or otherwise updated, as well as detail relating to when the attachment was added, removed, or otherwise updated. In the described embodiment, the contents of pop-up window 520 indicate that an attachment was added on Nov. 23, 2013 which was less than a year ago but more than a month ago.

It should be appreciated that information contained in pop-up windows 320, 420, 520 may vary widely. In one embodiment, pop-up windows 320, 420, 520 may include active hyperlinks to contextual information associated with changed data or a changed parameter. By way of example, pop-up window 320 of FIG. 3 may include a hyperlink to a document which summarizes risk rating definitions.

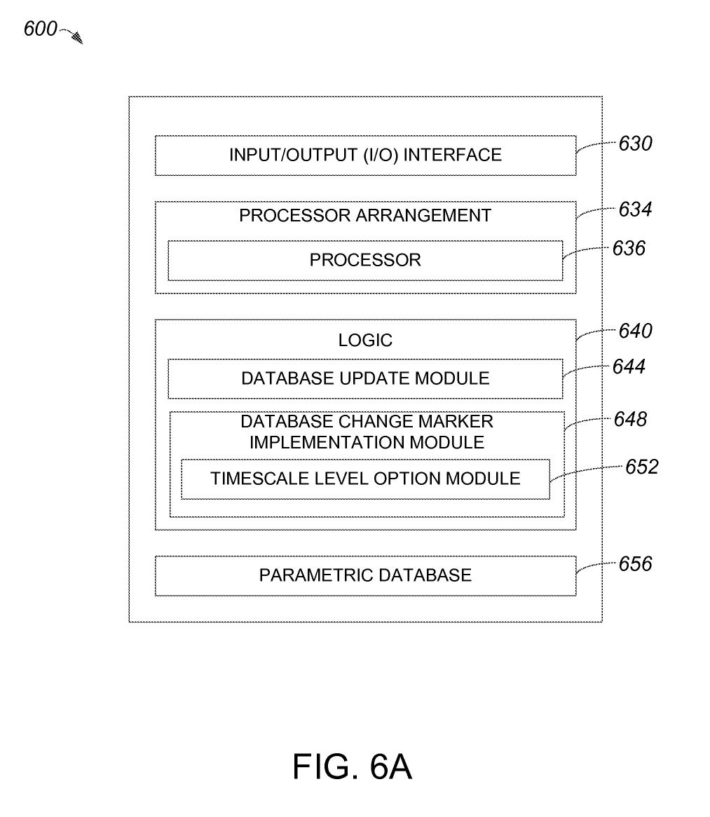

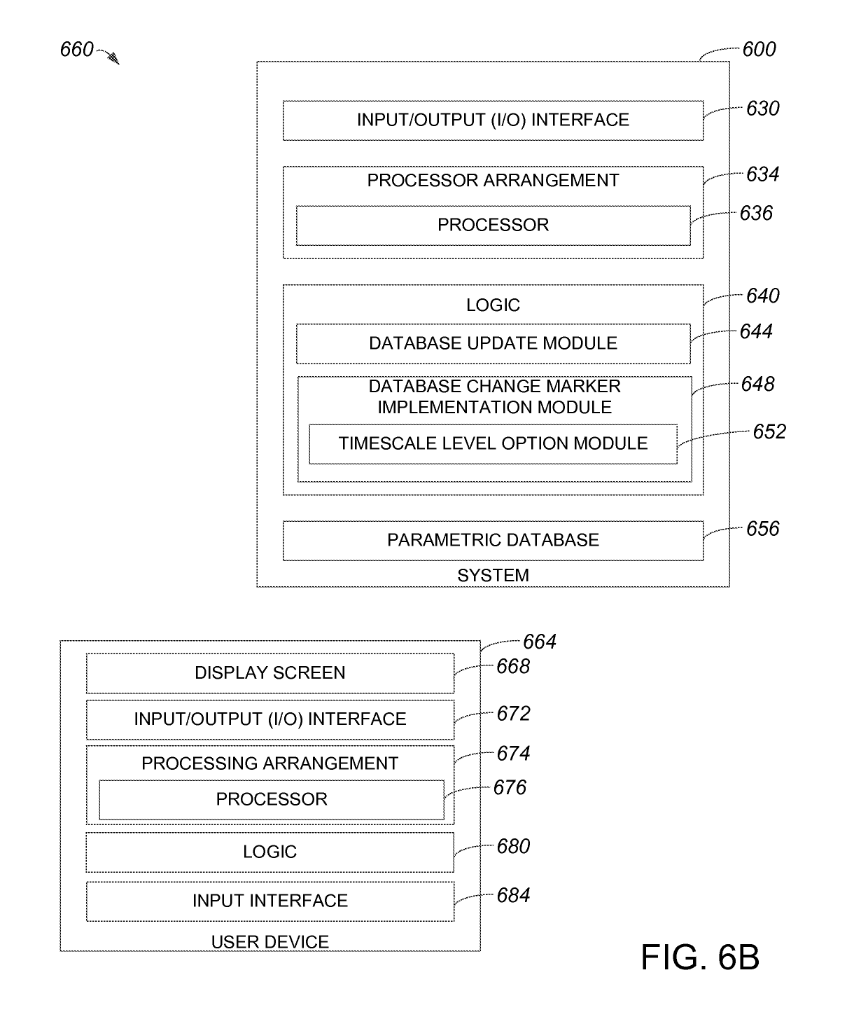

With reference to FIG. 6A, a system which supports data change and recency indications in accordance with an embodiment. A system 600 may generally be a computing system or other system which has computational capabilities, e.g., a server system. In one embodiment, the features and functionality of system 600 may be distributed among more than one element. That is, system 600 may be a distributed system.

System 600 includes an input/output (I/O) interface 630 which allows system 600 to communicate on a network. I/O interface 630 allows system 600 to send data and to receive data from other systems and/or devices on a network. Generally, I/O interface 630 includes at least one I/O port (not shown) on which data may be provided and obtained.

A processor arrangement 634 includes at least one processor 636 that executes logic 640. Logic 640 may include hardware and/or software logic embodied as executable program code devices. Logic 640 includes a database update module 644 and a database change marker implementation module 648. Database update module 644 is arranged to process and to otherwise support updates made to a parametric database 656. Database change marker implementation module 648 processes and otherwise supports providing change indicators with respect to changes in parametric database 656. Included in database change marker implementation module 648 is a timescale level option module 652 which is configured to allow customization with respect to how the recency of a change may be indicated, e.g., visually indicated.

As previously mentioned, system 600 is typically included in a network that supports other systems and/or devices which may communicate with system 600. Referring next to FIG. 6B, a network which includes system 600 will be described in accordance with an embodiment. A network 660 includes system 600 and at least one user device 664. User device 664 may generally be any device a user may use to communicate on a network with system 600. User device 664 may be, but is not limited to being, a computing device such as a laptop computer or a desktop computer, a tablet device, and/or cellular phone.

User device 664 generally includes a display screen 668, and I/O interface 672, a processing arrangement 674, logic 680, and an input interface 684. Display screen 668 is arranged to display or to otherwise render information relating to the contents of parametric database 656, including data change and recency indications. I/O interface 672 is configured to allow user device 664 to communicate with system 600 within network 660, and typically includes at least one I/O port (not shown). Processing arrangement 674 includes at least one processor 676, and is generally arranged to execute logic 680 which may include logic that allows contents of parametric database 656 to be rendered onto display screen 668. Input interface 684 is configured to obtain input, as for example from a user, that may be used to control or otherwise manipulate content that is displayed on display screen 668. It should be appreciated that when display screen 668 is a touchscreen, input interface 684 may effectively be included as a part of display screen 668.

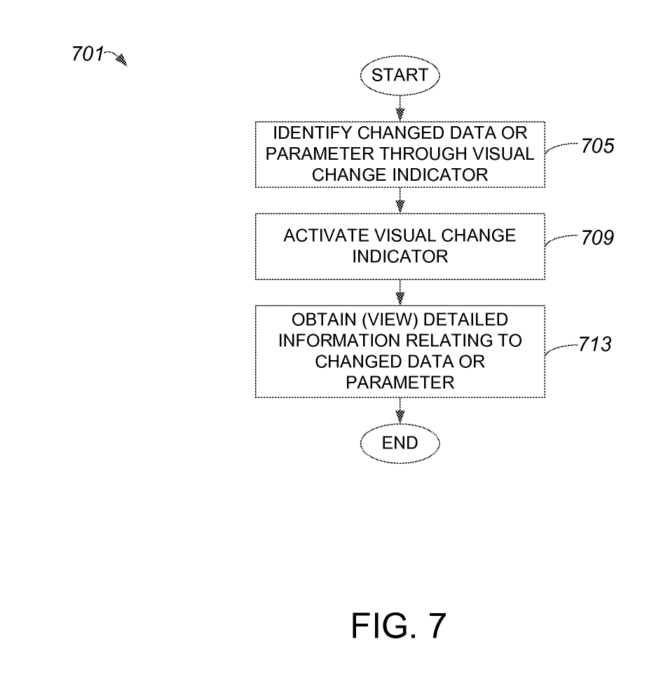

FIG. 7 is a process flow diagram of one method of utilizing a system which supports data change and recency indications, e.g., system 600 of FIG. 6A, in accordance with an embodiment. A method 701 of utilizing a system which supports data change and recency indications begins at step 705 in which changed data or a changed parameter is identified through a visual change indicator. Changed data or a changed parameter may generally be identified by a user when the user views a display on which a visual change indicator is rendered. In one embodiment, the changed data or the changed parameter may be displayed as part of a display of contents included in a database of the system.

In step 709, the visual change indicator is activated. Activating the visual change indicator may generally include a user using an input device to select or to highlight the visual change indicator displayed on a display screen. Once the visual change indicator is activated, detailed information relating to the changed data or the changed parameter may be obtained, e.g., viewed, in step 713. For example, once a user effectively selects a visual change indicator associated with the changed data or the changed parameter, a description of the changed data or the changed parameter may be displayed to the user. After detailed information relating to the changed data or the changed parameter is obtained, the method of utilizing a system which supports data change and recency indications is completed.

As mentioned above, the time scale associated with a visual indicator of the recency of a change may vary widely. In one embodiment, a time scale may be defined or otherwise set by a user. For example, while the presence of parentheses or brackets may denote a change in data or a change in a parameter, a user may assign specific quantitative meaning to sets of parentheses or brackets. That is, a specific time, time scale, and/or time range may be assigned to different sets of parentheses or brackets. Different users may, in some instances, specify different aspects of a time scale. End users may specify local custom settings, for example, while system administrators may specify system-wide standards or settings.

FIG. 8 is a diagrammatic representation of a user interface which allows a user to link qualitative indicators to specific quantitative definitions by specifying a time scale associated with visual indications of how recently a data change or a parameter change has occurred in accordance with an embodiment. A user interface 878 may be displayed on a display screen 800 associated with a database. User interface 878 may display visual indications 880a-c, and provide a user with the ability to select what each visual indication 880a-c represents in terms of a time scale. A user may flexibly assign a specific time span to each visual indication 880a-c. The user may manipulate the time spans associated with each visual indication 880a-c as appropriate, e.g., such that his or her view on a display is neither too cluttered nor too sparse in terms of visual indications of change.

In the embodiment as shown, visual indications 880a-c are represented by parentheses. As shown, visual indication 880a is a set of three pairs of open and closed parentheses or brackets, and represents that a change has occurred within a day as indicated at 882a. Visual indication 880b is a set of two pairs of open and closed parentheses, and represents that a change has occurred within a week as indicated at 882b, but more than a day ago. Visual indication 880c is set as a single pair of open and closed parentheses, and represents that a change has occurred within a year as indicated at 882c, but more than a week ago.

With respect to the settings shown in FIG. 8, when a change has occurred to a parameter within the last day, visual indication 880a may overlay the parameter in a display. When a parameter was changed more than a day ago, but within a week, visual indication 880b may overlay the parameter in a display. When a parameter was changed more than a week ago, but within a year, visual indication 880c may overlay the parameter in a display. It should be appreciated that when a parameter is determined to have changed more than a year ago, no visual indication overlays the parameter in the described embodiment.

A user interface for efficient parametric data change visualization allows for any data or parameters which have been changed to be recognized or otherwise identified by data change markers. In addition, the user interface provides indications which indicate a change recency and/or data freshness. That is, the user utilizes interface qualitative and quantitative indications with respect to data changes. By activating indications relating to a recency of a change, details or specifics associated with the change may be displayed to a user.

Although only a few embodiments have been described in this disclosure, it should be understood that the disclosure may be embodied in many other specific forms without departing from the spirit or the scope of the present disclosure. By way of example, while visual indicators have been shown as varying numbers of pairs of symbols such as parentheses, visual indicators are not limited to varying numbers of pairs of symbols such as parentheses. Any suitable visual indicators may be used to represent recent data or parameter changes, and to represent how recently the data or the parameter changes occurred.

The presence of a visual indication or marker icon which is superimposed with respect to a parameter, e.g., overlays or underlays a parameter, generally indicates that the parameter has changed. In one embodiment, the number of nested parentheses or brackets included in the visual indication indicates, qualitatively, how recently the parameter was changed. It should be appreciated that once a change is no longer considered to be recent, a visual indication which indicates that a parameter has changed may be removed.

In general, the number of visual indications used to represent how recently a data or parameter change has occurred may vary. Similarly, the time scale represented by each visual indication may also vary. Thus, although the use of three different visual indications has been described above, the present disclosure is not limited to the use of three different visual indications, as fewer than three and more than three visual indications may be used.

A visual indicator which identifies how recently a data change or a parameter change has occurred has been described as being an icon, text, and/or a color. It should be appreciated that visual indicators may generally take any suitable shape or form without departing from the spirit or the scope of the present disclosure. For example, a visual indicator may be a line or a shape with a thickness and/or a size that varies depending upon how recently an associated piece of data or parameter has been updated or otherwise changed.

In one embodiment, a visual indicator may effectively show motion and may change color to indicate the recency of a change. The methods used to implement a visual indicator may depend upon a type of the visual indicator, as well as the type of change associated with a parameter. For instance, a visual indicator may move, e.g., be displayed as vibrating, or change colors to indicate how recently a particular piece of data or parameter has changed. In another embodiment, different types of changes may be signified by different visual indicators or different implementations of the same visual indicators. By way of example, a visual indicator which indicates that a parameter has gone from being non-existent to existent may be different from a visual indicator which indicates that a value of a parameter has changed from one value to another value.

A pop-up window in which details associated with a data change or a parameter change has generally been described as including details of the data change or the parameter change. It should be appreciated that such details are not limited to details relating to the most recent change. For instance, details shown in a pop-up window may include information which identifies older changes as well as the most recent change. In other words, a pop-up window may display details associated with the history of changes for a particular data element or parameter.

In one embodiment, a visual indication may be arranged to indicate the magnitude of a change. By way of example, if a numerical value of a parameter changes, a visual indication that is displayed as an overlay on the parameter may be arranged to indicate how much the numerical value has changed. For instance, the thickness of parentheses used to identify the recency of a change may be used to express how much of a change has occurred, e.g., thicker parentheses may indicate a larger magnitude of change.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, structures, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
determining when a change has occurred with respect to a first piece of data, the first piece of data being stored in a database;
causing the first piece of data to be displayed on a display screen, the display screen being in communication with the database; and
causing a visual indication to be displayed on the display screen, the visual indication being arranged to be superimposed with respect to the first piece of data on the display screen, the visual indication being configured to visually indicate at least one selected from a group including qualitative information and quantitative information associated with the change, wherein the visual indication is arranged to be activated to cause details associated with the change to be displayed on the display screen.

2. The method of claim 1 wherein the details include information relating to when the change occurred.

3. The method of claim 2 wherein the details further include information relating to the first piece of data before the change and information relating to the first piece of data after the change.

4. The method of claim 1 wherein the qualitative information is indicated by an existence of the visual indication and the quantitative information is indicated by a configuration of the visual indication.

5. The method of claim 4 wherein the configuration of the visual indication is arranged to indicate how recently the change occurred.

6. The method of claim 4 wherein the visual indication includes at least a first symbol, wherein when the visual indication includes only the first symbol, the quantitative information indicates a first time range associated with how recently the change occurred.

7. The method of claim 6 wherein when the visual indication includes the first symbol and a second symbol, the quantitative information indicates a second time range associated with how recently the change occurred.

8. Logic encoded in one or more tangible non-transitory, computer-readable media for execution and when executed operable to:
determine when a change has occurred with respect to a first piece of data, the first piece of data being stored in a database;
cause the first piece of data to be displayed on a display screen, the display screen being in communication with the database; and
cause a visual indication to be displayed on the display screen, the visual indication being arranged to be superimposed with respect to the first piece of data on the display screen, the visual indication being configured to visually indicate at least one selected from a group including qualitative information and quantitative information associated with the change, wherein the visual indication is arranged to be activated to cause details associated with the change to be displayed on the display screen.

9. The logic of claim 8 wherein the details include information relating to when the change occurred.

10. The logic of claim 9 wherein the details further include information relating to the first piece of data before the change and information relating to the first piece of data after the change.

11. The logic of claim 8 wherein the qualitative information is indicated by an existence of the visual indication and the quantitative information is indicated by a configuration of the visual indication.

12. The logic of claim 11 wherein the configuration of the visual indication is arranged to indicate how recently the change occurred.

13. The logic of claim 11 wherein the visual indication includes at least a first symbol, wherein when the visual indication includes only the first symbol, the quantitative information indicates a first time range associated with how recently the change occurred.

14. The logic of claim 13 wherein when the visual indication includes the first symbol and a second symbol, the quantitative information indicates a second time range associated with how recently the change occurred.

15. An apparatus comprising:
a processor;
a database; and
a module, the module including computer-readable media for execution by the processor, the module being configured to determine when a change has occurred with respect to a first piece of data stored in the database, to cause the first piece of data to be displayed on a display screen in communication with the database, and to cause a visual indication to be displayed on the display screen, the visual indication being arranged to be superimposed with respect to the first piece of data on the display screen and configured to visually indicate at least one selected from a group including qualitative information and quantitative information associated with the change, wherein the visual indication is arranged to be activated to cause details associated with the change to be displayed on the display screen.

16. The apparatus of claim 15 wherein the details include information relating to when the change occurred, information relating to the first piece of data before the change, and information relating to the first piece of data after the change.

17. The apparatus of claim 15 wherein the qualitative information is indicated by an existence of the visual indication and the quantitative information is indicated by a configuration of the visual indication.

18. The apparatus of claim 17 wherein the configuration of the visual indication is arranged to indicate how recently the change occurred.

19. The apparatus of claim 17 wherein the visual indication includes at least a first symbol, wherein when the visual indication includes only the first symbol, the quantitative information indicates a first time range associated with how recently the change occurred.

20. The apparatus of claim 19 wherein when the visual indication includes the first symbol and a second symbol, the quantitative information indicates a second time range associated with how recently the change occurred.
